(19) United States
(12) Patent Application Publication
(10) Pub. No.: US 2014/0093632 A1
(43) Pub. Date: Apr. 3, 2014

(54) PROCESS FOR MANUFACTURING MODIFIED STARCH

(71) Applicant: JAPAN CORN STARCH CO., LTD., Tokyo (JP)

(72) Inventors: Yuri Sakakibara, Hekinan-shi (JP); Atsuki Okamoto, Hekinan-shi (JP)

(73) Assignee: JAPAN CORN STARCH CO., LTD., Tokyo (JP)

(21) Appl. No.: 14/119,248

(22) PCT Filed: May 25, 2012
(86) PCT No.: PCT/JP2012/063462

§ 371 Date: Nov. 21, 2013

(30) Foreign Application Priority Data
May 26, 2011 (JP) 2011-118117

(51) Int. Cl. A23L 1/0522

(52) U.S. Cl. CPC A23L 1/05223
USPC 426/578

(57) ABSTRACT

Process for manufacturing modified starch. A powdery starch composition raw material, containing a specified amount of a phosphate with respect to a raw material starch on a dry basis, is subject to esterification modification by performing a first step of heat treating by raising a temperature gradually and performing, in continuation, a second step of heat treating at a constant temperature. A temperature rise starting temperature of the first step is set within a range from an ordinary temperature to a temperature no more than a gelatinization starting temperature of the raw material starch, a temperature rise rate is set to 0.2 to 1° C./min, and a temperature rise final temperature is set to 120 to 180° C. The constant temperature treatment is normally performed at the temperature rise final temperature.

### TECHNICAL FIELD

The present invention relates to a process for manufacturing a modified starch that is high in gel strength, excellent in aging resistance, etc., and favorable for seafood and livestock paste products.

In the present specification and claims, “parts” and “%” that indicate blending units are mass units unless noted otherwise.

Also, a “water content” of a starch raw material or a starch composition raw material, etc., signifies a “wet basis water content percentage.”

### BACKGROUND ART

Conventionally in a seafood paste product, such as a boiled fish paste cake (kamaboko), a tube-shaped boiled fish paste cake (chikuwa), or a deep-fried boiled fish paste cake (age-kamaboko), etc., a starch is ordinarily used not only simply as a filler but also to improve a cleanly-sliceable yet highly elastic food texture unique to seafood paste products, and a starch is also blended in a binder for meat in a livestock paste product, such as a meatball, hamburger, etc., to improve elasticity and binding property of the products.

As such a starch for paste products, mainly potato starch and wheat starch are being used so far. However, the former potato starch, although having advantages of being good in water texturizing property and high in elasticity-enhancing effect, has disadvantages that a product tends to become hard with elapse of time and that a phenomenon in which water separates to a surface of a product, in other words, an aging phenomenon proceeds at a fast rate. On the other hand, although wheat starch is excellent in aging resistance as an unmodified starch, it has disadvantages of being poor in water texturizing property and elasticity-enhancing effect.

Meanwhile, although as a type of starch, cornstarch is widely known, is inexpensive, and has stable quality, it does not swell sufficiently when used in the abovementioned paste products, is thus poor in elasticity-enhancing effect and aging resistance in comparison to the other types of starch, and is thus unavoidably restricted in application and has a critical disadvantage in that it can only be used in a limited field of paste products.

An unmodified starch used in paste products thus has both advantages and disadvantages, such as being good in elasticity-enhancing effect and water texturizing property but poor in aging resistance or being excellent in aging resistance but poor in elasticity-enhancing effect and water texturizing property. Cornstarch in particular has several problems, such as not being capable of use in ordinary paste products and being capable of use only in a limited field of paste products due to the above reasons.

Although a starch is also used in noodles, etc., for the purpose of elasticity enhancement and an improvement in food texture, it has the disadvantage of being poor in the elasticity-enhancing effect,

Various attempts have thus been made to apply an advanced chemical treatment to an unmodified starch to improve its physical properties and use the modified starch in paste products. For example, methods of using an oxyalkyletherified starch (Patent Literature 1), an oiled starch (Patent Literatures 2, 3, and 4), or a starch phosphate ester, starch sodium octenyl succinate, or starch ammonium octenyl succinate with a substitution degree of 0.005 to 0.3 (Patent Literature 5), etc., as a modified starch, and a starch for seafood and livestock paste products characterized in being modified so that a phosphate esterification degree is within a range of no less than 0.001 and less than 0.005 (Patent Literature 6), etc., have been proposed.

However, these modified starches cannot necessarily be said to be sufficient in all of aging resistance, water texturizing property, and elasticity-enhancing effect for use in paste products and have problems in that the modifying (processing) treatment is troublesome and also disadvantageous economically, etc.

Although not influencing the patentability of the present invention, a “seafood paste product,” which contains a wet treated tapioca starch for a purpose of improving quality in a paste product in a manner similar to the present invention, is proposed in Patent Literature 7 and a “cereal flour composition for tubular flour paste cake (chikuwabu),” which contains a phosphate-crosslinked starch, is proposed in Patent Literature 8, respectively.

### CITATION LIST

### Patent Literature

Patent Literature 1: JP No. Sho-45-31347 B (claims, etc.)

Patent Literature 2: JP No. Sho-45-32898 B(claims, etc.)

Patent Literature 3: ibid 56-1920 B(claims, etc.)

Patent Literature 4: ibid 56-46387 B(claims, etc.)

Patent Literature 5: ibid 61-36897 B(claims, etc.)

Patent Literature 6: JP No. Sho-63-221103 A(claims, etc.)

Patent Literature 7: JP No. 2010-227084 A(claims, etc.)

Patent Literature 8: JP No. 2010-252716 A (claims, etc.)

### SUMMARY OF INVENTION

### Technical Problem

An object of the present is to provide a process for manufacturing modified starch, which resolves the above problems, with which a modification treatment is simple, and which provides a modified starch having a good elasticity-enhancing effect and is also excellent in water texturizing property and aging resistance.

### Solution to Problem

As a result of continuing diligent research toward manufacturing a modified starch having such excellent features, the present inventors found that a modified starch (chemically modified starch), obtained by subjecting a powdery starch composition raw material, with which a predetermined amount of any of various types of phosphates is contained in a starch, to a gradual temperature rise heat treatment from a temperature no more than a starch gelatinization starting temperature and thereafter to a constant temperature heat treatment at a final temperature of the gradual temperature rise heat treatment for a predetermined time, can meet the above object and have thereby completed the present invention.

The present invention shall now be described in detail.

A reaction rate and a reaction mechanism differ according to a raw material starch, phosphate, pH, water content, etc. Numerical conditional ranges related to the manufacturing process according to the present invention in the following description are thus merely indicated as implementable prima facie standards for the sake of clarifying the present invention,

As examples of a starch used as a raw material in the present invention, for example, cornstarch (CS), waxy cornstarch, wheat starch, rice starch, sweet potato starch, tapioca starch, sago starch, potato starch, etc., can be cited, and one type of such a starch may be used or two or more types may be used upon mixing. Among these, it is preferable for CS, which is conventionally viewed as being difficult to use due to having a critical disadvantage for paste products, to be used as the raw material.

As a phosphate useable in the present invention, an orthophosphate, pyrophosphate, or tripolyphosphate, etc., can be cited, and for example, a phosphate, such as sodium phosphate, potassium phosphate, sodium polyphosphate, potassium polyphosphate, etc., can be cited, and one type of such a phosphate may be used or two or more types may be used upon mixing,

A content of the phosphate in a starch composition raw material, although varying slightly according to the type of starch and the type of phosphate, is normally 0.1 to 8 parts, preferably 0.3 to 5 parts, and more preferably 0.5 to 3.5 parts per 100 parts of starch on a dry basis.

Here, when the phosphate content is excessively low, a gel strength, which is an object of the present invention, tends to be insufficient and sufficient improvements in elasticity-enhancing effect, water texturizing property, and aging resistance are difficult to achieve in case of use in a seafood paste product. On the other hand, when the phosphate content is excessively high, a color tone of the modified starch takes on a brownish tint, and in case of use of the modified starch in a paste product, there is a tendency for the product to be sticky in a manner such that a cut section of the product is stringy or a cleanly-sliceable food texture unique to the paste product to be rather lost.

As a method for adding the phosphate, either of a wet method, that is, a method of adding and mixing in the phosphate after putting the raw material starch into slurry form with water, and a dry method, that is, a method of spraying and mixing a phosphate solution into the raw material starch is used.

Here, a pH value of the starch after the addition of phosphate must be adjusted in accordance with the type and quality of the raw material starch used or the type of phosphate, etc., to be in a range of normally pH 6 to 9 and preferably in a range of 7.5 to 8.5. When the pH value is not in accordance with the types of the raw material starch and the phosphate, adjustment is performed as appropriate with a generally used pH adjuster.

In a case where the phosphate-added starch (starch composition raw material) is obtained by the wet method as described above, the raw material is in a slurry form or is excessive in water content and is thus normally dried by heat to be made into a powdery starch composition raw material. The water content of the starch composition raw material is normally 10 to 25% and preferably 15 to 22%. In a case of the dry method, the raw material is normally obtained as a powder with an appropriate water content and drying by heating is thus unnecessary as a rule.

Preferably, an appropriate amount of a sugar alcohol is contained in the starch composition raw material by adding at the same time as or adding separately from the phosphate. It has been confirmed that this can lessen coloration of the modified starch obtained through a high temperature heat treatment at no less than 100° C. and thereby improve whiteness (Table 2).

A content of the sugar alcohol differs according to the required whiteness and is normally 0.01 to 5 parts, preferably 0.05 to 2 parts, and more preferably 0.1 to 1 part with respect to 100 parts of starch on a dry basis,

When the sugar alcohol content is excessively low, it is difficult to obtain the whiteness improving effect. On the other hand, when the sugar alcohol content is excessively high, it may influence, in case of use in a paste product, a flavor or physical property of the paste product and application of the modified starch of the present invention may thereby be restricted,

As the sugar alcohol, that which is produced by hydrogenation of a starch hydrolyzate, such as hydrogenated starch syrup, maltitol, sorbitol, xylitol, mannitol, etc., can be cited. One type of such a sugar alcohol may be used or two or more types may be used upon mixing,

The starch composition raw material that has thus been prepared is modified through a gradual temperature rise heat treatment (first step) and a constant temperature heat treatment (second step) described below.

<Gradual Temperature Rise Heat Treatment (First Step)>

A temperature rise starting temperature, a temperature rise rate, and a final temperature are set as described below.

The temperature rise starting temperature is selected as appropriate from a range from ordinary temperature to a temperature no more than the gelatinization starting temperature of the raw material starch, preferably from a range from 40° C. to (gelatinization starting temperature minus 5° C.), and more preferably from a range from normally 45° C. to (gelatinization starting temperature minus 10° C.). When the temperature rise starting temperature is too low, a temperature rise heat treatment time takes too long and productivity is poor. On the other hand, when a temperature higher than the gelatinization starting temperature is set as the temperature rise starting temperature, gelatinization may occur. The gelatinization starting temperature is, for example, 66.8° C. in the case of CS and 61.0° C. in the case of potato starch (cited from “Table 3,5 Gelatinization temperatures of various types of starch” in Jiro Nikuni, supervising editor, “Handbook of Starch Science” (1977), Asakura Publishing Co., Ltd., p. 36).

The temperature rise rate is set to 0.2 to 1° C./min and preferably 0.4 to 0.8° C./min. Here, if the temperature rise rate is too slow, it takes too much time to reach the predetermined temperature rise final temperature and productivity of the modified starch is poor. On the other hand, when the temperature rise rate is too fast, the raw material starch may gelatinize due to rapid heating.

The final temperature is set as appropriate in a range of normally 120 to 180° C. and preferably 130 to 150° C. When the temperature rise final temperature is too low, it tends to be difficult for esterification (practically, monoesterification) to proceed sufficiently and it is difficult to obtain a product of high substitution degree (modification degree) (substitution degree of nearly 0.2).

<Constant Temperature Heat Treatment (Second Step)>

The temperature is then held in a range of temperature rise final temperature ±10° C. and preferably temperature rise final temperature ±5° C. for 0.5 to 10 h and preferably 1 to 5 h to perform the constant temperature heat treatment. The phosphate esterification (mainly, monoesterification) is completed by the constant temperature heat treatment.

From standpoints of productivity, color protection, etc., it is preferable to set the temperature rise starting temperature and the final temperature so that a total heat treatment time of the gradual temperature rise heat treatment (first step) and the constant temperature heat treatment (second step) falls within 2 to 15 h and more preferably within 3 to 8 h.

The modified starch (mostly starch monophosphate) mixture of the present invention thus manufactured preferably has the following amylogram characteristics.

It is favorable for gelatinization viscosity characteristics in an amylogram measured with a starch concentration of 8% (dry basis) be such that (1) a temperature at which an amylo-viscosity of 20 BU is exhibited be in a range of 66 to 72° C., (2) the amylo-viscosity at a temperature of 75° C. be in a range of no less than 600 BU, (3) a maximum amylo-viscosity be in a range of no less than 800 BU, and (4) a temperature at which the maximum amylo-viscosity is exhibited be in a range of 70 to 85° C.

Here, when the temperature in (1) is too low and the temperature in (4) is too low, although the aging resistance is improved and the starch is thus fit for practical use, it is difficult to obtain the elasticity-enhancing effect. On the other hand, when the temperature in (1) is too high, the amylo-viscosity in (2) is too low, the maximum amylo-viscosity in (3) is too low, and the temperature in (4) is too high, the degrees of improvement in elasticity-enhancing effect, water texturizing property, and aging resistance are low in comparison to cases where the above ranges are satisfied.

The amylogram refers to that measured using Amylo-Graph made by Brabender GmbH under conditions of a temperature rise rate of 1.5° C./min, a rotation speed of 75 rpm, and with 1000 Brabender units (BU)=700 cm·g.

By the present invention, even CS, which was heretofore difficult to use despite being inexpensive and stable in quality, can be used as a starch for paste products.

Also, the modified starch manufactured by the process of the present invention can be used favorably as a starch for seafood and livestock paste products,

In such cases, although the modified starch may be used alone, it is expected that the actions and effects of the present invention can be exhibited sufficiently even in combined use with an unprocessed (unmodified) starch or a lightly modified starch,

The unmodified starch or the lightly modified starch is not restricted in particular, and, an unmodified starch or lightly modified starch of CS, waxy CS, potato starch, wheat starch, sweet potato starch, tapioca starch, rice starch, etc., can be used. Advantageous Effects of Invention

The process for manufacturing modified starch according to the present invention is a process by which a starch can be modified to a modified starch of high commercial value that is good in elasticity-enhancing effect and also excellent in water texturizing property and aging resistance, and is a process for manufacturing a modified starch that is suitable for a livestock paste product, noodles, etc, The process for manufacturing modified starch according to the present invention also has a merit of enabling use of CS, which was difficult to use for paste products despite being inexpensive and stable in quality as a raw material, as an alternative to potato starch.

### EXAMPLES

Examples and application examples implemented for confirming the effects of the present invention shall now be described.

### A. Preparation of Modified Starch:

Modified starches of the respective examples were prepared as indicated below. The slurry pH and the compositions and water contents of the starch composition raw materials are summarized in Table 1 and the heat treatment conditions are summarized in Table 2.

TABLE 11

| | | Starch composition raw material | | | |
|---|---|---|---|---|---|
| | | | Na poly- | | Water |
| | Slurry pH | CS | phosphate | Maltitol | content (%) |
| Example 1 | 7.9 | 100 parts | 2.7 part | — | 19 |
| Example 2 | 8.2 | 100 parts | 3.0 part | — | 15 |
| Example 3 | 8.2 | 100 parts | 3.0 part | 0.2 part | 19 |
| Example 4 | 8.2 | 100 parts | 1.0 par | 0.6 part | 15 |

TABLE 2

| | Gradual temperature rise heat treatment | | | | Constant | |
|---|---|---|---|---|---|---|
| | Temperature | Temperature | | | temperature | Starch |
| | rise starting | rise final | Temperature | Temperature | heat treat- | white- |
| | temperature | temperature | rise rate | rise time | ment time | ness |
| Example 1 | 55° C. | 145° C. | 0.5° C./min | 3 h | 2 h | 81 |
| Example 2 | 50° C. | 140° C. | 0.6° C./min | 2.5 h | 2 h | 82 |
| Example 3 | | | | | | 89 |
| Example 4 | | | | | | 90 |

### Example 1

After dispersing 1000 parts of cornstarch with a water content of 13.0% in 1200 parts of water while stirring, 70 parts of Na tripolyphosphate were added and dissolved to prepare a starch slurry, and further the pH was adjusted to 7.9 using a basic pH adjuster.

The starch slurry was then dewatered to a water content of 35% and then further dried at 50° C. to obtain a dried product (starch composition raw material) with a water content of 19%. The Na polyphosphate contained in the starch composition raw material was 2.7 parts with respect to 100 parts of starch on a dry basis.

The starch composition raw material was then placed in a hot air circulation dryer maintained at 55° C., the temperature was raised from a temperature rise starting temperature of 55° C. to a temperature rise final temperature of 145° C. over a period of 3 h (average temperature rise rate: 0.5° C./min), and in continuation to the gradual temperature rise heat treatment (first step), a constant temperature heat treatment was performed by holding at the temperature rise final temperature of 145° C. for 2 hours. The modified starch obtained had a whiteness as measured by a whiteness tester of 81.

### Example 2

Besides adding and dissolving the sodium tripolyphosphate at an added amount of 75 parts by mass, a starch slurry was prepared in the same manner as in Example 1. The starch slurry had a pH of 8.2 and pH adjustment was not performed.

Then in the same manner as in Example 1, the starch slurry was dewatered to a water content of 35% and then further dried to obtain a dried product (starch composition raw material) with a water content of 19%. The Na polyphosphate contained in the starch composition raw material was 3.0 parts with respect to 100 parts of starch on a dry basis.

The starch composition raw material was then placed in the hot air circulation dryer maintained at 50° C., and the temperature rise heat treatment was performed by raising the temperature from a temperature rise starting temperature of 50° C. to a temperature rise final temperature of 140° C. over a period of 2 h (average temperature rise rate: 0.6° C./min). In continuation, the constant temperature heat treatment was performed by holding the temperature rise final temperature of 140° C. for 2 hours. The modified starch obtained had a whiteness of 82.

### Example 3

Besides adding maltitol at an added amount of 5 parts in addition to the 75 parts of Na tripolyphosphate, a starch slurry with a pH of 8.2 was prepared in the same manner as in Example 2.

Then in the same manner as in Example 1, the starch slurry was dewatered to a water content of 35% and then further dried to obtain a dried product (starch composition raw material) with a water content of 19%. The contents of Na polyphosphate and maltitol contained in the starch composition raw material were 3.0 parts and 0.2 parts, respectively, with respect to 100 parts of starch on a dry basis.

The starch composition raw material was then placed in the hot air circulation dryer maintained at 50° C. and the gradual temperature rise heat treatment and the constant temperature heat treatment were performed under the same conditions as in Example 2. The modified starch obtained had a whiteness of 89.

### Example 4

Besides setting the added amount of Na tripolyphosphate to 25 parts and the added amount of maltitol to 15 parts, a starch slurry with a pH of 8.2 was prepared in the same manner as in Example 3.

Then in the same manner as in Example 1, the starch slurry was dewatered to a water content of 35% and then further dried to obtain a dried product (starch composition raw material) with a water content of 15%. The contents of Na polyphosphate and maltitol contained in the starch composition raw material were 1.0 part and 0.6 parts, respectively, with respect to 100 parts of starch on a dry basis.

The starch composition raw material was then placed in the hot air circulation dryer maintained at 50° C. and the gradual temperature rise heat treatment and the constant temperature heat treatment were performed under the same conditions as in Example 2. The modified starch obtained had a whiteness of 90.

The pH values were measured using “pH Meter F52” (made by HORIBA, Ltd.) and the whiteness values were measured using “Whiteness Tester NW” (made by NIPPON DENSHOKU INDUSTRIES Co., LTD.).

<Amylogram Test>

For the modified CS of the respective examples obtained as described above, amylograms were measured with a starch concentration of 8% (dry basis) using Amylo-Graph made by Brabender GmbH under the conditions mentioned above, and the results are shown in Table 3.

TABLE 3

| | Amylogram measured with starch | | | |
|---|---|---|---|---|
| | concentration of 8% by weight (dry basis) | | | |
| | | | | Temperature |
| | Temperature | | | at which |
| | at which | Amylo- | | maximum |
| | amylo-viscosity | viscosity at | Maximum | amylo- |
| | of 20 BU | temperature | amylo- | viscosity |
| Sample | is exhibited | of 75° C. | viscosity | is exhibited |
| Example 1 | 68 | 1200 | 1350 | 77 |
| Example 2 | 69 | 1100 | 1280 | 78 |
| Example 3 | 67 | 1250 | 1400 | 76 |
| Example 4 | 68 | 1180 | 1340 | 77 |
| Control | 77 | 45 | 680 | 92 |
| example (un- | | | | |
| modified CS) | | | | |

B. Application Examples (Preparation of Paste Products)

Paste products (application examples) manufactured using the modified starches of the respective examples prepared as described above to confirm the effects of the present invention shall now be described.

### Application Examples 1 to 4

100 parts of class A frozen minced walleye pollock were thawed and after performing rough grinding for 5 minutes using a grinder, 3 parts of table salt were added and salt grinding was performed for 15 minutes. Further, 1 part of sodium glutamate, 3 parts of sugar, 3 parts of sweet sake (mirin), 40 parts of ice water, and 10 parts of the modified CS obtained in an example among the respective examples were then added and after mixing for 10 minutes, the mixture was packed into a Saran casing tube and both ends of the tube were bound. The packed product was then boiled for 40 minutes at 90° C. and thereafter cooled to obtain a kamaboko in casing,

<Physical Property Tests of Paste Product>

Physical properties of respective Application Examples (paste products) 1 to 4 corresponding to Examples 1 to 4 manufactured thus were then determined as follows.

(1) Indentation Strength:

The kamaboko in casing of 3 cm diameter was cut to a circular cylinder of 3 cm thickness, and to this sample, a load was applied at a rate of 6 cm/min by a 5.0 mm diameter plunger using a rheometer (made by SUN SCIENTIFIC CO., LTD.) and an indentation strength and a size of indentation were measured.

(2) Gel Strength:

A gel strength was determined by the following formula.

Gel strength=Indentation strength×Size of indentation

(3) Stability:

For the sample of each application example (paste product) stored at 5° C., rates of change of the gel strength 7 days later and 14 days later with the gel strength 1 day later being 1.00 were evaluated as the stability.

As a control application example, besides using unmodified CS in place of the modified starch, a kamaboko in casing was prepared in the same manner as in Application Example 1 of the present invention.

Changes of physical properties with time of the kamabokos were determined.

From Table 4, which shows the results, it was found that in cases where the modified CS of the respective examples were used, the indentation strength and the size of indentation are large, that is, the elasticity-enhancing effect is large. It was also found that the stability is high and the aging resistance is excellent.

In Patent Literature 5, it is described that a gel stability at 10 days later of a kamaboko in casing of Example 1, prepared by blending a conventional CS phosphate monoester at the same proportion in thawed frozen walleye pollock and performing the same procedure as in the application examples of the present invention, is 1.14 (12.0/10.5) (second table). It is thus evident that the gel stability (1.08) at 14 days later of Example 1 of the present invention using the modified starch is excellent.

TABLE 4

| | Storage | Indentation | Inden- | Gel | |
|---|---|---|---|---|---|
| | period | strength | tation | strength | |
| Sample | (days) | (g) | (mm) | (g · m) | Stability |
| Application | 1 | 322 | 7.1 | 2286 | — |
| Example 1 | 7 | 335 | 7.2 | 2412 | 1.06 |
| | 14 | 342 | 7.2 | 2462 | 1.08 |
| Application | 1 | 319 | 7.2 | 2297 | — |
| Example 2 | 7 | 328 | 7.3 | 2394 | 1.04 |
| | 14 | 339 | 7.2 | 2441 | 1.06 |
| Application | 1 | 330 | 7.2 | 2376 | — |
| Example 3 | 7 | 335 | 7.3 | 2446 | 1.03 |
| | 14 | 339 | 7.4 | 2509 | 1.06 |
| Application | 1 | 325 | 7.3 | 2373 | — |
| Example 4 | 7 | 335 | 7.4 | 2479 | 1.04 |
| | 14 | 340 | 7.3 | 2482 | 1.05 |
| Control | 1 | 237 | 6.8 | 1612 | — |
| Application | 7 | 380 | 6.9 | 1932 | 1.20 |
| Example | 14 | 346 | 7.0 | 2422 | 1.50 |
| (unmodified CS) | | | | | |

Sensory tests were also performed on the kamabokos at 7 days later. As an evaluation method, a panel of 20 members performed evaluation and the evaluation result was expressed as an average score by a five-step evaluation with the control application example being evaluated as 3 points and 5 points being given to an extremely good product, 4 points given to a good product, 3 points given to a product equivalent to the control, 2 points given to a poor product, and 1 point to an extremely poor product. The results are shown in Table 5.

From these results, it was confirmed that kamabokos using the modified CS of the respective examples of the present invention were clearly excellent in elasticity and cleanly-slicing quality in comparison to the kamaboko using the unmodified CS

Although a seafood paste product was used as an example here, it is considered that similar results can be obtained with a livestock paste product as well,

TABLE 5

Sensory Evaluation

| Sample No. | Elasticity | Cleanly-slicing quality |
|---|---|---|
| Application Example 1 | 4.3 | 3.9 |
| Application Example 2 | 4.2 | 3.8 |
| Application Example 3 | 4.5 | 4.0 |
| Application Example 4 | 4.3 | 3.9 |
| Control Application | 3.0 | 3.0 |
| Example (unmodified CS) | | |

1. A process for manufacturing modified starch,
wherein a modified starch is manufactured by subjecting a powdery starch composition raw material, containing 0.1 to 8 parts of a phosphate with respect to 100 parts of a raw material starch on a dry basis, to
a first step of heat treating by gradually raising a temperature from a starting temperature, set within a range from an ordinary temperature to a temperature no more than a gelatinization starting temperature of the raw material starch, to a final temperature of 120 to 180° C. at a temperature rise rate of 0.2 to 1° C./min and
a second step of heat treating at a constant temperature in continuation to the first step by maintaining the temperature within ±10° C. of the final temperature in the gradual temperature rise heat treatment for 0.5 to 10 h.

2. The process for manufacturing modified starch according to claim 1, wherein the starch composition raw material further contains 0.01 to 5 parts of a sugar alcohol with respect to 100 parts of the raw material starch on a dry basis.

3. The process for manufacturing modified starch according to claim 1, wherein the raw material starch is cornstarch.

4. The process for manufacturing modified starch according to claim 1, wherein a water content of the starch composition raw material is 10 to 25%.

5. A paste product comprising a modified starch manufactured by the process according to claim 1.

6. The process for manufacturing modified starch according to claim 2, wherein the raw material starch is cornstarch.

7. The process for manufacturing modified starch according to claim 2, wherein a water content of the starch composition raw material is 10 to 25%.

8. The process for manufacturing modified starch according to claim 3, wherein a water content of the starch composition raw material is 10 to 25%.

9. The process for manufacturing modified starch according to claim 6, wherein a water content of the starch composition raw material is 10 to 25%.

10. A paste product comprising a modified starch manufactured by the process according to claim 2.

11. A paste product comprising a modified starch manufactured by the process according to claim 3.

12. A paste product comprising a modified starch manufactured by the process according to claim 4.

13. A paste product comprising a modified starch manufactured by the process according to claim 6.

14. A paste product comprising a modified starch manufactured by the process according to claim 7.

15. A paste product comprising a modified starch manufactured by the process according to claim 8.

16. A paste product comprising a modified starch manufactured by the process according to claim 9.
